(19) United States
(12) Patent Application Publication
(10) Pub. No.: US 2006/0274719 A1
(43) Pub. Date: Dec. 7, 2006

(54) FAST-PATH NAVIGATION SYSTEM AND METHOD

(75) Inventors: Patrick R. Guido, Cary, NC (US); Steven P. Kim, Raleigh, NC (US); Robert C. Leah, Cary, NC (US); Paul F. McMahan, Apex, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/908,935

(22) Filed: Jun. 1, 2005

(51) Int. Cl. H04L 12/28

(52) U.S. Cl. 370/351

(57) ABSTRACT

A fast-path navigation method and system may include facilitating selection of a destination node in a multi-layered system for bookmarking. The fast-path navigation method and system may also include facilitating selection of a source node in the multi-layered system and creating a fast-path or direct link from the source node to the bookmarked destination node.

### BACKGROUND OF THE INVENTION

The present invention relates to navigating or moving between nodes, resources, files or other items that may be represented in a multi-layered hierarchical system, series of directories, tree diagram or the like, and more particularly to a fast-path navigation, system and method for quickly and efficiently moving between nodes or items in a multi-layered system.

Within the context of any system used to store resources containing specific information or the like, the storage of such resource is constrained in a hierarchical system, usually dictated by a series of directories, with each directory contained at a specific level. When navigating to a specific object, node, resource or the like, located n levels deep, users are forced to traverse the n levels manually. Upon reaching the desired level, the user must then scan the contents of the level for the specific resource. In addition, when traversing each level, users must also scan for the entry point to advance to the next level of the hierarchical system. These navigation issues may be compounded even further in a web-based environment in which the web client has limited capabilities. Within a web environment, each click results in a round-trip to a web-server in addition to resetting the scroll position of the navigation container.

### BRIEF SUMMARY OF THE INVENTION

In accordance with an embodiment of the present invention, a fast-path navigation method may include facilitating selection of a destination node in a multi-layered system for bookmarking. The fast-path navigation method may also include facilitating selection of a source node in the multi-layered system; and creating a fast-path from the source node to the bookmarked destination node.

In accordance with another embodiment of the present invention, a fast-path system may include means for facilitating selection of a destination node in a multi-layered system for bookmarking. The fast-path system may also include means for facilitating selection of a source node in the multi-layered system. The fast-path system may further include means for creating a fast path from the source node to the bookmarked destination node.

In accordance with another embodiment of the present invention, a computer program product for fast-path navigation in a multi-layered system may include a computer readable medium having computer readable program code embodied therein. The computer readable medium may include computer readable program code configured to facilitate selection of a destination node for bookmarking. The computer readable medium may also include computer readable program code configured to facilitate selection of a source node and computer readable program code configured to create a fast-path from the source node to the bookmarked destination node.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A and 1B (collectively FIG. 1) are a flow chart of an example of a fast-path navigation method in accordance with an embodiment of the present invention.

FIGS. 2A, 2B and 2C are each examples of a representation of a multi-layer system illustrating a fast-path navigation method and system and features of the method and system in accordance with an embodiment of the present invention.

FIG. 3 is a block diagram of an exemplary system for fast-path navigation in accordance with an embodiment of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following detailed description of preferred embodiments refers to the accompanying drawings, which illustrate specific embodiments of the invention. Other embodiments having different structures and operations do not depart from the scope of the present invention.

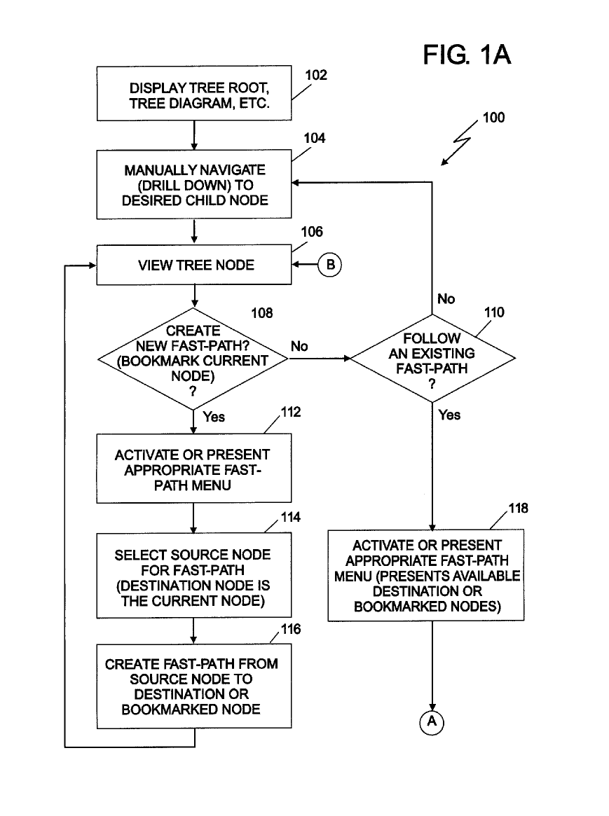

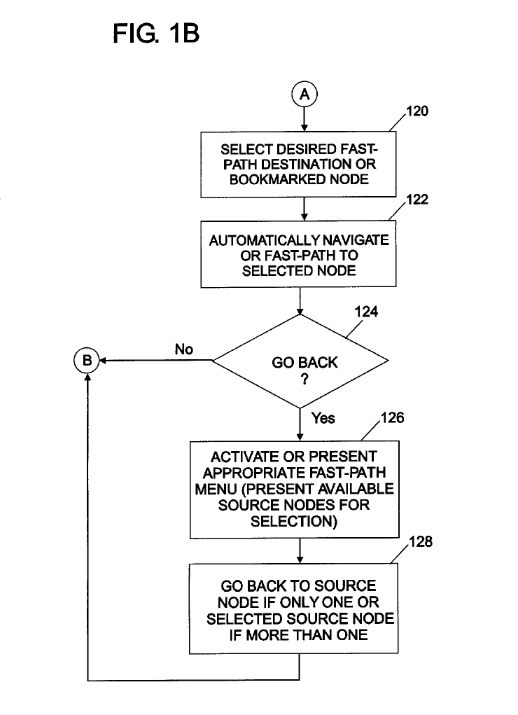

FIGS. 1A and 1B (collectively FIG. 1) are a flow chart of an example of a fast-path navigation method 100 in accordance with an embodiment of the present invention. In block 102, a tree root, tree diagram or the like may be displayed. The tree root or tree diagram may be a representation of a multi-layered, hierarchical system or the like to store resources or other objects that may contain information or data.

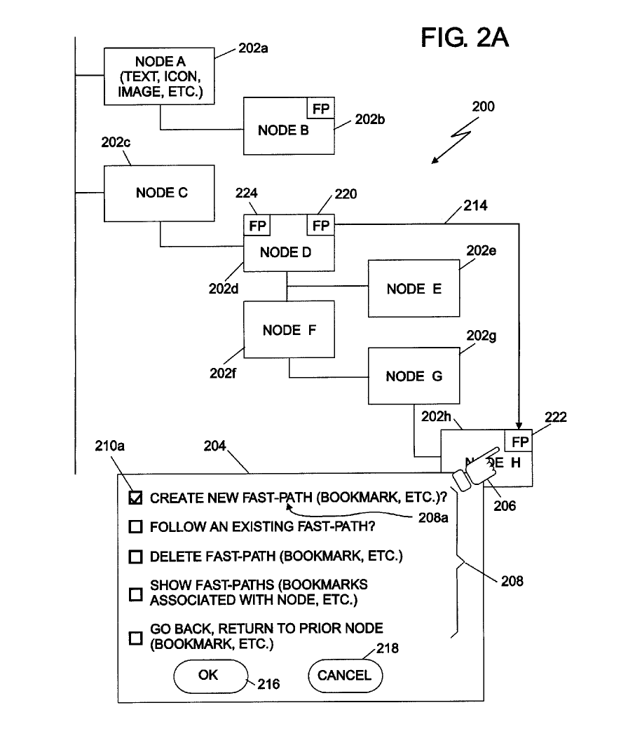

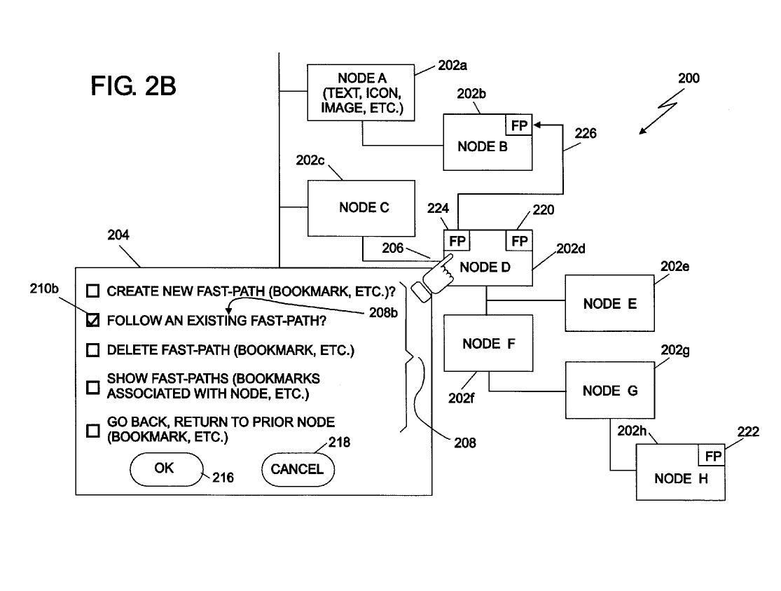

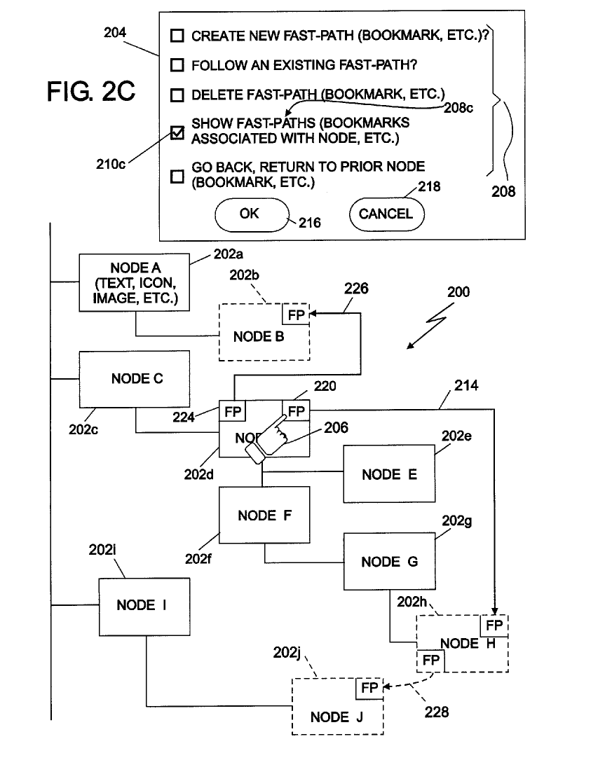

In block 104 a user may manually navigate or drill down to select a desired node, child node or sub-node in the tree diagram or multi-layered system. As used herein, the term node may refer to any resource, object, or item that may be represented or contained in a multi-layered hierarchical system such as the system 200 illustrated in FIGS. 2A-2C. In block 106, the selected node or node navigated to in block 104 may be viewed. In block 108, an option whether to create a new fast-path or bookmark the current node may be presented. In one embodiment of the present invention a fast-path menu may be presented including a plurality of options associated with a selected or chosen node. An example of a tree diagram representation of a multi-layered system that may be presented and different options that may be presented in a fast-path menu will be described in more detail with reference to FIGS. 2A-2C.

If the option to create a new fast-path in block 108 is not selected, the method 100 may advance to block 110. If the option to create a new fast-path in block 108 is selected, the method may advance to block 112. In block 112, an appropriate fast-path menu may be activated or presented. An example of a fast-path menu will be described with reference to FIGS. 2A-2C.

In block 114, a source node for the fast-path may be selected. The current node or node drilled down to in block 104 will be the destination node. In block 116, a fast-path or direct link may be created from the source node to the destination node. Accordingly, when at the source node, a user can navigate directly or fast-path to the destination node without having to tediously navigate through the multi-layered system or directories.

After creating the fast-path in block 116, the method 100 may return to block 106 where the tree node or destination node may be viewed and additional fast-paths may be created or the existing fast-path may be followed in block 110. In block 110, an option may be presented whether to follow an existing fast-path. If the option is not selected, the method 100 may return to block 104 and the method 100 may proceed as previously described. If the option to follow an existing fast-path is selected, the method 100 may advance to block 118. In block 118, an appropriate fast-path menu may be activated or presented. As previously mentioned, an example of a fast-path menu will be described in more detail with reference to FIGS. 2A-2C. The menu may include an option to present available destination or bookmarked nodes associated with a current node or a source node.

In block 120, a desired fast-path destination or bookmarked node may be selected. In block 122, the method 100 may automatically navigate or fast-path to the selected destination node.

In block 124, an option may be presented whether to go back or return to the previous node. Accordingly, a return link may be provided to the previous bookmarked node or location. If the option to go back is not selected in block 124, the method 100 may return to block 106 and the current tree node may be viewed. If the option to go back is selected in block 124, the method 100 may advance to block 126. In block 126, an appropriate fast-path menu may be activated or presented. The menu may present available source nodes associated with the current node and may also present available destination nodes if fast-paths have been created from the current node as a source node to other destination nodes. In block 128, the system or method may go back to the source node if only one, or the system or method may go back to a source node that is selected if more than one.

FIGS. 2A, 2B and 2C are each examples of a representation 200 of a multi-layer system illustrating a fast-path navigation method and system and features of the method and system in accordance with an embodiment of the present invention. As previously discussed, each node 202 may represent a resource containing information or data, a file, a folder or other item in a hierarchical system. Each node 202 may include an identification of the type resource or information stored. Examples of the identification may include descriptive text, an icon, an image or the like.

As previously discussed with respect to method 100 in FIG. 1, a user may manually navigate or drill down to a desired child node, such as node H 202h. A fast-path menu 204 may be presented in response to a predetermined action. The predetermined action may be a right click on the node 202h with a computer pointing device, mouse or the like corresponding to a mouse symbol 206 on a computer monitor or display. The fast-path menu 204 may include a plurality of different options 208. A checkbox 210 or the like may be associated with each option to select between the different options 208. Examples of the different options 208 may include “create a new fast-path, bookmark or the like”; “follow an existing fast-path”; “delete a fast-path, bookmark or link”; “show fast-paths or bookmarks associated with the node”; “go back” or “return to a prior node or book mark”; or similar options.

If the “create a new fast-path” option 208a is selected by checking box 210a, as illustrated in FIG. 2A, a source node may be selected for the current node 202h. The current node 202h becomes a destination node when the fast-path is created. In the example of FIG. 2A, node D 202d may be selected as the source node and a fast-path represented by the arrow 214 may be created between node D 202d and node H 202h. The fast-path 214 may actually be created in response to clicking-on or activating a button 216 that may be labeled “OK” or some other descriptive label to signal to the system or method the user's intent to perform the option 208 selected. If the user does not want to have the selected option 208 performed, a “Cancel” button 218 or the like may be clicked-on or operated using the computer pointing device 206. The existence of the fast-path 214 may be indicated in node D 202d by an indicator 220, such as by a box within node D 202d that may be labeled “FP”, “Fast-Path” or other similar indicator. A similar indication 222 of the existence of a fast-path 214 may also be shown in association with node H 202h. The fast-path 214 may be presented or displayed in response to a predetermined action, such as hovering over either of the nodes 202d or 202h, or fast-path indicators 220 and 222 with the computer pointing device symbol 206, right clicking-on the node 202d or 202h or fast-path indicator 220 or 222, or some other predetermined action.

FIG. 2B is an example of selecting the “follow an existing fast-path” option 208b in the fast-path menu 204. As previously discussed, the fast-path menu 204 may be presented by a predetermined action, such as right clicking-on a representation of a chosen node 202d or clicking-on a fast-path indicator 224 within the representation of the node 202d, hovering over the chosen node 202d or fast-path indicator 224 with the computer pointing device symbol 206, or some other predetermined action. A representation of an existing fast-path (arrow 226) may also be presented to illustrate the existing fast-path 226 or direct link from the chosen or source node 202d to the destination node 202b in response to a predetermined action. The predetermined action may include selecting the “follow an existing fast path” option 208b, a predetermined clicking action relative to the node 202d or fast-path indicator 224 or other predetermined action. The existing fast-path may then be followed to node B 202b in response to clicking-on or otherwise activating the “OK” button 216. The system may then link directly to the destination node without the user having to navigate through several intermediate steps or operations.

FIG. 2C is an example of selecting a “show fast-paths or bookmarks associated with a node” option 208c. Similar to that previously discussed, the fast-path menu 204 may be presented or displayed in response to a predetermined action, such as clicking-on a node or fast-path indicator or other action using a computer pointing device 206 or the like. All fast-paths associated with the chosen node 202d may be presented. Just the immediate nodes linked by fast-paths directly from the chosen node may be presented or a chain of cascading fast-paths from the chosen node to a first node and then fast-paths from the first node to other subsequent nodes in a chain may be presented. For example, only fast-paths 214 and 226 linking directly from the chosen node 202d may be presented or these fast-paths in addition to a cascade of subsequent fast-paths may be shown, like fast-path 228 between node 202h and 202j and any further fast-paths. This illustrates a dynamic look-ahead bookmark or fast-path feature from any chosen node in accordance with an embodiment of the present invention.

Destination nodes, such as nodes 202h, 202b and 202j, may be highlighted (as represented by the broken line boxes in FIG. 2c) to distinguish them from source nodes. Cascaded fast-paths, such as fast-path 228, may also be highlighted in some manner, as illustrated by the broken line in FIG. 2C.

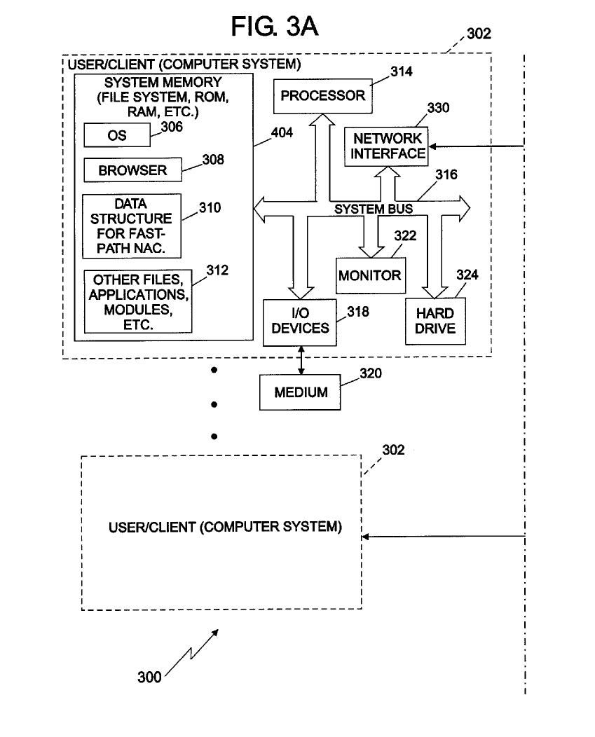

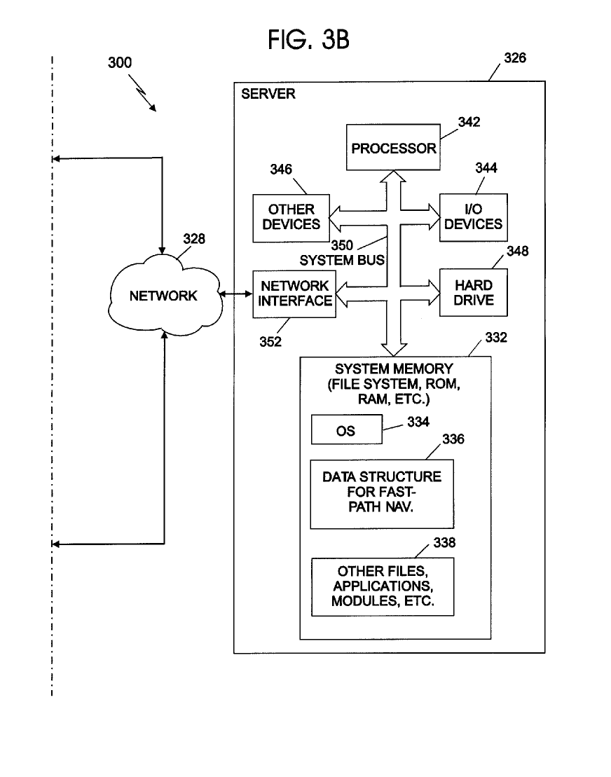

FIG. 3 is a block diagram of an exemplary system 300 for fast-path navigation in accordance with an embodiment of the present invention. The elements of the method 100 may be embodied in and performed by the system 300 and the tree diagram or system topology diagrams illustrated in FIGS. 2A-2C may be presented or displayed by the system 300. The system 300 may include one or more user or client devices or computer systems 302.

The computer system 302 may include a system memory 304 or local file system. The system memory 304 may include a read only memory (ROM) and a random access memory (RAM) (not shown). The ROM may include a basic input/output system (BIOS) (not shown). The BIOS may contain basic routines that help to transfer information between elements or components of the computer system 302. The system memory 304 may contain an operating system 306 to control overall operation of the computer system 302. The system memory 304 may also include a browser 308 or web browser. The system memory 304 may also include data structures 310 or computer-executable code for performing fast-path navigation operations and features that may be similar or include elements of the method 100 in FIGS. 1A and 1B and permit performance of the functions and features illustrated and described with respect to FIGS. 2A-2C. The system memory 304 may further include other files, applications, modules or the like 312, which may be used in conjunction with the method 100 in FIGS. 1A and 1B to facilitate fast-path navigation.

The computer system 302 may also include a processor or processing unit 314 to control operations of the other components of the computer system 302. The operating system 306, browser 308, data structures 310 may be operable on the processor 314. The processor 314 may be coupled to the memory system 304 and other components of the computer system 302 by a system bus 316.

The computer system 302 may also include multiple input devices, output devices or combination input/output devices 318. Each input/output device 318 may be coupled to the system bus 316 by an input/output interface (not shown in FIG. 3). The input and output devices or combination I/O devices 318 permit a user to operate and interface with the computer system 302 and to control operation of the browser 308 and data structures 310 to access, operate and control the software for fast-path navigation operations. The I/O devices 318 may include a keyboard and computer pointing device or the like to perform the operations discussed herein, such making selections in the fast-path menu 204 (FIGS. 2A-2C).

The I/O devices 318 may also include disk drives, optical, mechanical, magnetic, or infrared input/output devices, modems or the like. The I/O devices 318 may be used to access a medium 320. The medium 320 may contain, store, communicate or transport computer-readable or computer-executable instructions or other information for use by or in connection with a system, such as the computer systems 302.

The computer system 302 may also include or be connected to other devices, such as a display or monitor 322. The monitor 322 may be used to permit the user to interface with the computer system 302. The monitor 322 may present the tree diagrams illustrated in FIGS. 2A-2C that may be generated by the data structures 310 for fast-path navigation.

The computer system 302 may also include a hard disk drive 324. The hard drive 324 may be coupled to the system bus 316 by a hard drive interface (not shown in FIG. 4). The hard drive 324 may also form part of the local file system or system memory 304. Programs, software and data may be transferred and exchanged between the system memory 304 and the hard drive 324 for operation of the computer system 302.

The computer systems 302 may communicate with a remote server 326 and may access other servers or other computer systems similar to computer system 302 via a network 328. The system bus 316 may be coupled to the network 328 by a network interface 330. The network interface 330 may be a modem, Ethernet card, router, gateway or the like for coupling to the network 328. The coupling may be a wired connection or wireless. The network 328 may be the Internet, private network, an intranet or the like.

The server 326 may also include a system memory 332 that may include a file system, ROM, RAM and the like. The system memory 332 may include an operating system 334 similar to operating system 306 in computer systems 302. The system memory 332 may also include data structures 336 for fast-path navigation similar to the functions and operations described herein. The system memory 332 may also include other files, applications, modules or the like 338 to perform functions related to fast-path navigation or other functions and operations.

The server 326 may also include a processor 342 or a processing unit to control operation of other devices in the server 326. The server 326 may also include I/O device 344. The I/O devices 344 may be similar to I/O devices 318 of computer systems 302. The server 326 may further include other devices 346, such as a monitor or the like to provide an interface along with the I/O devices 344 to the server 326. The server 326 may also include a hard disk drive 348. A system bus 350 may connect the different components of the server 326. A network interface 352 may couple the server 326 to the network 328 via the system bus 350.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A fast-path navigation method, comprising:
facilitating selection of a destination node in a multi-layered system for bookmarking;
facilitating selection of a source node in the multi-layered system; and
creating a fast-path from the source node to the bookmarked destination node.

2. The fast-path navigation method of claim 1, further comprising following an existing fast-path in response to selecting a previously bookmarked destination node.

3. The fast-path navigation method of claim 1, further comprising presenting a fast-path menu to present a plurality of different options associated with a node.

4. The fast-path navigation method of claim 1, further comprising presenting any available fast-paths associated with a chosen node in response to a predetermined user action.

5. The fast-path navigation method of claim 4, wherein the predetermined user action comprises one of:
selecting a follow an existing fast-path option in a fast-path menu;
a click-on action associated with the chosen node; and
hovering over the chosen node with a computer pointing device.

6. A system operable for performing the method of claim 1.

7. A computer-readable medium having computer-executable instructions for performing the method of claim 1.

8. The fast-path navigation method of claim 1, further comprising providing a return link to a previous node.

9. The fast-path navigation method of claim 1, further comprising providing a look-ahead of bookmarked nodes from a current node.

10. A fast-path system, comprising:
means for facilitating selection of a destination node in a multi-layered system for bookmarking;
means for facilitating selection of a source node in the multi-layered system; and
means for creating a fast-path from the source node to the bookmarked destination node.

11. The fast-path system of claim 10, further comprising means for following an existing fast-path in response to selecting a previously bookmarked destination node.

12. The fast-path system of claim 10, further comprising means for presenting any available fast-paths associated with a chosen node in response to a predetermined user action.

13. The fast-path system of claim 10, further comprising a return link to a previous node.

14. The fast-path system of claim 10, further comprising a fast-path menu to present a plurality of different options associated with a chosen node.

15. The fast-path system of claim 14, wherein the plurality of different options comprises at least one of:
create a new fast-path;
follow an existing fast-path;
delete an existing fast-path;
present fast-paths associated with a chosen node; and
return to a prior node.

16. A computer program product for fast-path navigation, comprising:
computer readable medium having computer readable program code embodied therein, the computer readable medium comprising:
computer readable program code configured to facilitate selection of a destination node for bookmarking;
computer readable program code configured to facilitate selection of a source node; and
computer readable program code configured to create a fast-path from the source node to the bookmarked destination node.

17. The computer program product of claim 16, further comprising computer readable program code configured to follow an existing fast-path in response to selecting a previously bookmarked destination node.

18. The computer program product of claim 16, further comprising computer readable program code configured to present a fast-path menu to present a plurality of different options associated with a node.

19. The computer program product of claim 16, further comprising computer readable program code configured to present any available fast-paths associated with a chosen node in response to a predetermined user action.

20. The computer program product of claim 16, further comprising:
computer readable program code configured to provide a return link to a previous node; and
computer readable program code configured to provide a look-ahead of bookmarked nodes from a current node.
